(19) United States
(12) Patent Application Publication
(10) Pub. No.: US 2026/0005997 A1
(43) Pub. Date: Jan. 1, 2026

(54) DATA PROCESSING METHOD, ELECTRONIC DEVICE, AND NON-TRANSITORY STORAGE MEDIUM

(71) Applicant: Beijing Zitiao Network Technology Co., Ltd., Beijing (CN)

(72) Inventor: Jing LIU, Beijing (CN)

(21) Appl. No.: 19/171,593

(22) Filed: Apr. 7, 2025

(30) Foreign Application Priority Data
Jun. 28, 2024 (CN) 202410868687.4

(51) Int. Cl. H04L 61/45; H04N 21/2187; H04N 21/262

(52) U.S. Cl. CPC H04L 61/45; H04N 21/2187; H04N 21/26208

(57) ABSTRACT

Embodiments of the present disclosure provide a data processing method, an electronic device, and a non-transitory storage medium. The method includes: acquiring, when at least one target node cluster corresponding to a multimedia data stream acquisition request is found based on a pre-created mapping relationship, target stream pulling information of a current node cluster corresponding to the multimedia data stream acquisition request; and determining, when the target stream pulling information meets a preset condition, a target server address corresponding to the multimedia data stream acquisition request based on node information of nodes in the at least one target node cluster and the current node cluster so that a multimedia server provides a target service corresponding to the multimedia data stream acquisition request based on the target server address.

### CROSS-REFERENCE TO RELATED APPLICATIONS

This application claims the priority to and benefits of the Chinese Patent Application, No.202410868687.4, which was filed on Jun. 28, 2024. The aforementioned patent application is hereby incorporated by reference in its entirety.

### TECHNICAL FIELD

Embodiments of the present disclosure relate to the field of data processing technologies, and in particular, to a data processing method, an electronic device, and a non-transitory storage medium.

### BACKGROUND

With the vigorous development of the internet live streaming industry in recent years, a proportion of the total internet application traffic that live streaming bandwidth traffic accounts for is also experiencing rapid growth. Currently, when a user has a stream pulling request for a specific live stream, a corresponding bandwidth network is usually allocated for the stream pulling request of the user based on the principle of server geographical proximity.

However, this bandwidth scheduling policy based on the principle of geographical proximity results in a case that a small number of servers provide live streaming services to a large number of users, and a large number of servers provide live streaming services to a small number of users. Consequently, there are problems of unbalanced resource allocation and a low utilization rate of bandwidth resources during distribution of network bandwidth resources for live stream pulling requests in a live streaming scenario.

### SUMMARY

The present disclosure provides a data processing method, an electronic device, and a non-transitory storage medium, to solve a problem of unbalanced resource allocation during distribution of network bandwidth resources for live stream pulling requests in a live streaming scenario, and increase a utilization rate of the network bandwidth resources.

In a first aspect, an embodiment of the present disclosure provides a data processing method. The method includes:
acquiring, when at least one target node cluster corresponding to a multimedia data stream acquisition request is found based on a pre-created mapping relationship, target stream pulling information of a current node cluster corresponding to the multimedia data stream acquisition request, where the mapping relationship includes stream name information to be selected and a node cluster to be selected; and
determining, when the target stream pulling information meets a preset condition, a target server address corresponding to the multimedia data stream acquisition request based on node information of nodes in the at least one target node cluster and the current node cluster, so that a multimedia server provides a target service corresponding to the multimedia data stream acquisition request based on the target server address.

According to a second aspect, an embodiment of the present disclosure further provides an electronic device. The electronic device includes:
one or more processors; and
a storage apparatus configured to store one or more programs, where
the one or more programs, when executed by the one or more processors, cause the one or more processors to implement any data processing method provided in the embodiments of the present disclosure.

According to a third aspect, an embodiment of the present disclosure further provides a non-transitory storage medium having computer-executable instructions, where the computer-executable instructions, when executed by a computer processor, are used to perform any data processing method provided in the embodiments of the present disclosure.

In the technical solutions of the embodiments of the present disclosure, the at least one target node cluster corresponding to the multimedia data stream acquisition request is queried based on the pre-created mapping relationship when the multimedia data stream acquisition request is received. In addition, the target stream pulling information of the current node cluster corresponding to the multimedia data stream acquisition request is acquired. Further, the target server address corresponding to the multimedia data stream acquisition request is determined based on the node information of the nodes in the at least one target node cluster and the current node cluster when the target stream pulling information meets the preset condition, so that the multimedia server provides the target service corresponding to the multimedia data stream acquisition request based on the target server address. In the technical solutions of the embodiments of the present disclosure, because the mapping relationship stores multimedia stream name information with a high user browsing frequency and a node cluster to be selected that corresponds to these multimedia stream names, and a quantity of stream pulling requests corresponding to the node cluster to be selected is relatively large, when a quantity of stream pulling requests of the current node cluster is relatively small, stream pulling requests the same as the multimedia stream name information in the current node cluster are aggregated to the target node cluster. Hence, a problem of unbalanced resource allocation during distribution of network bandwidth resources for live stream pulling requests in a live streaming scenario is solved, and a utilization rate of the network bandwidth resources is increased.

### BRIEF DESCRIPTION OF DRAWINGS

The foregoing and other features, advantages, and aspects of embodiments of the present disclosure become more apparent with reference to the following specific implementations and in conjunction with the accompanying drawings. Throughout the drawings, the same or similar reference numerals denote the same or similar elements. It should be understood that the accompanying drawings are schematic and that parts and elements are not necessarily drawn to scale.

FIG. 1 is a schematic diagram of an architecture of a network bandwidth aggregation scheduling system according to an embodiment of the present disclosure;

FIG. 2 is a schematic diagram of a system architecture of a content delivery network for live streaming according to an embodiment of the present disclosure;

FIG. 3 is a schematic flowchart of a data processing method according to an embodiment of the present disclosure;

FIG. 4 is a schematic flowchart of an implementation of determining a mapping relationship according to an embodiment of the present disclosure;

FIG. 5 is a schematic flowchart of another data processing method according to an embodiment of the present disclosure;

FIG. 6 is a schematic flowchart of an implementation of determining a target server address according to an embodiment of the present disclosure;

FIG. 7 is a schematic diagram of a structure of a data processing apparatus according to an embodiment of the present disclosure; and

FIG. 8 is a schematic diagram of a structure of an electronic device according to an embodiment of the present disclosure.

### DETAILED DESCRIPTION

The embodiments of the present disclosure are described in more detail below with reference to the accompanying drawings. Although some embodiments of the present disclosure are shown in the accompanying drawings, it should be understood that the present disclosure may be implemented in various forms and should not be construed as being limited to the embodiments set forth herein. Rather, these embodiments are provided for a more thorough and complete understanding of the present disclosure. It should be understood that the accompanying drawings and the embodiments of the present disclosure are only for exemplary purposes, and are not intended to limit the scope of protection of the present disclosure.

It should be understood that the various steps described in the method implementations of the present disclosure may be performed in different orders, and/or performed in parallel. Furthermore, additional steps may be included and/or the execution of the illustrated steps may be omitted in the method implementations. The scope of the present disclosure is not limited in this respect.

The term “include/comprise” used herein and the variations thereof are an open-ended inclusion, namely, “include/comprise but not limited to”. The term “based on” is “at least partially based on”. The term “an embodiment” means “at least one embodiment”. The term “another embodiment” means “at least one another embodiment”. The term “some embodiments” means “at least some embodiments”. Related definitions of the other terms will be given in the description below.

It should be noted that concepts such as “first” and “second” mentioned in the present disclosure are only used to distinguish different apparatuses, modules, or units, and are not used to limit the sequence of functions performed by these apparatuses, modules, or units or interdependence.

It should be noted that the modifiers “one” and “a plurality of” mentioned in the present disclosure are illustrative and not restrictive, and those skilled in the art should understand that unless the context clearly indicates otherwise, the modifiers should be understood as “one or more”.

The names of messages or information exchanged between a plurality of apparatuses in the implementations of the present disclosure are used for illustrative purposes only, and are not used to limit the scope of these messages or information.

It can be understood that before the use of the technical solutions disclosed in the embodiments of the present disclosure, the user shall be informed of the type, range of use, use scenarios, etc., of personal information involved in the present disclosure in an appropriate manner in accordance with the relevant laws and regulations, and the authorization of the user shall be acquired.

For example, in response to reception of an active request from the user, prompt information is sent to the user to clearly inform the user that a requested operation will require access to and use of the personal information of the user. As such, the user can independently choose, based on the prompt information, whether to provide the personal information to software or hardware, such as an electronic device, an application, a server, or a storage medium, that performs operations in the technical solutions of the present disclosure.

As an optional but non-limiting implementation, in response to the reception of the active request from the user, the prompt information may be sent to the user in the form of, for example, a pop-up window, in which the prompt information may be presented in text. Furthermore, the pop-up window may further include a selection control for the user to choose whether to “agree” or “disagree” to provide the personal information to the electronic device.

It can be understood that the above process of notifying and acquiring the authorization of the user is only illustrative and does not constitute a limitation on the implementations of the present disclosure, and other manners that satisfy the relevant laws and regulations may also be applied in the implementations of the present disclosure.

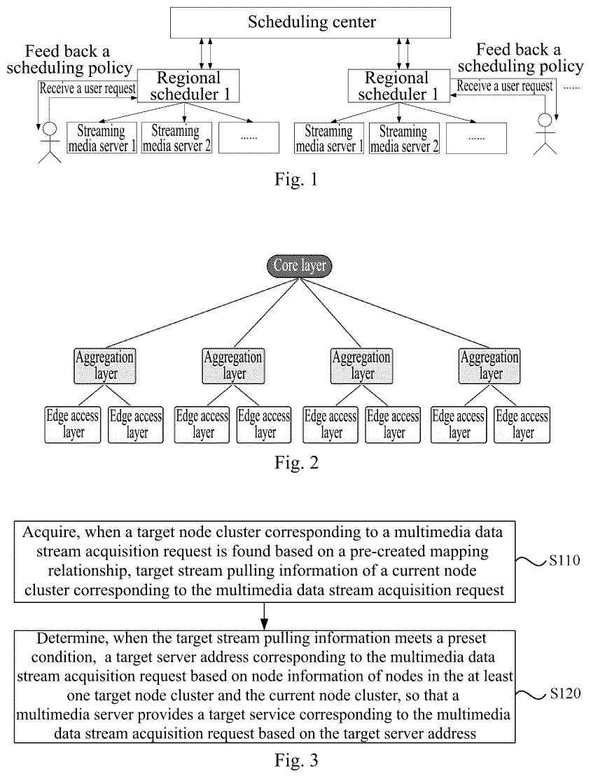

Embodiments of the present disclosure are performed under the following architecture of a network bandwidth aggregation scheduling system. For a schematic diagram of the architecture of the network bandwidth aggregation scheduling system, refer to FIG. 2. As shown in FIG. 2, the network bandwidth aggregation scheduling system includes a scheduling center, regional schedulers, and streaming media servers. The scheduling center is associated with at least one regional scheduler, and one regional scheduler is associated with at least one streaming media server. Each regional scheduler corresponds to one predetermined spatial region with a larger range. A plurality of streaming media servers are configured in the spatial region. Each streaming media server corresponds to one predetermined spatial region with a smaller range. The scheduling center may receive data information provided by all regional schedulers or deliver a scheduling instruction to all regional schedulers.

For example, in a specific application process, the scheduling center has the following functions: filtering, in real time, target live streaming channels in which a quantity of online users is greater than a preset threshold; determining, based on a quantity of live streaming pulling of a current target live streaming channel in a regional node cluster and a first preset threshold, whether the regional node cluster is a target node cluster corresponding to the target live streaming channel; and if the regional node cluster is the target node cluster corresponding to the current target live streaming channel, establishing a mapping relationship between the current target live streaming channel and the target node cluster. The scheduling center may further receive a stream pulling scheduling policy request sent by the regional scheduler, to determine a target stream pulling scheduling policy. For example, an implementation of determining the target stream pulling scheduling policy is as follows: When a user has a stream pulling requirement for a live streaming channel, a stream pulling request corresponding to the live streaming channel may be generated. According to target stream name information carried in the stream pulling request corresponding to the target user, when it is determined that the target stream name information is stored in the mapping relationship and a quantity of stream pulling requests of a regional cluster to be processed to which the stream pulling request belongs is small, a transferable target node cluster corresponding to the target stream name information is determined according to the mapping relationship; and the transferable target node cluster is delivered to the regional scheduler.

The regional scheduler has the following functions: sending the stream pulling scheduling policy request to the scheduling center when the stream pulling request of the target user is received, to determine whether there is a transferable target node cluster or not; performing loop closure detection on the live streaming channel corresponding to the stream pulling request, after the transferable target node cluster delivered by the scheduling center is received; and determining a target server address according to a loop closure detection result, and feeding back the target server address to the target user. In this way, the streaming media server corresponding to the target user may provide a live streaming service corresponding to the stream pulling request based on the target server address.

Optionally, this embodiment may be applied in a scenario in which a live streaming service is provided using an architecture of a content delivery network (CDN) for live streaming. The architecture of the CDN network and a problem currently faced when the architecture of the CDN network is used to implement live streaming traffic distribution are described below. For a schematic diagram of a system architecture of the CDN network, refer to FIG. 2. As shown in FIG. 2, the CDN network includes an edge access layer, an aggregation layer, and a core layer.

The CDN network works as follows: In response to that a user requests resources for a live video stream (that is, a stream pulling request), the user may access the edge access layer. In response to that the edge access layer has the resources for the live video stream, the edge access layer directly provides the service. In response to that the edge access layer does not have the resources for the live video stream, the edge access layer performs back-to-origin to request the aggregation layer for the resources. In response to that the aggregation layer does not have the resources either, the aggregation layer performs back-to-origin to request an origin site of the core layer for the resources. Back-to-origin refers to a behavior of requesting stream pulling from a higher-level node if a required live stream does not exist in a node proximal to the user after the user accesses the node.

In the above context, a typical procedure of distributing network bandwidth resources for a multimedia data stream pulling request is as follows: Before a live streaming service is accessed, a user requests, by using a local domain name system (LDNS), an authoritative domain name system (ADNS) supported in the CDN for live streaming to query an IP address corresponding to a live streaming service domain name to be accessed (that is, the live streaming source end), and then requests the regional scheduler in the CDN for live streaming based on the IP address. The regional scheduler in the CDN for live streaming further allocates a geographically proximal server IP address to the user according to information such as an IP address of the user. The user finally successfully accesses the live streaming service. However, this scheduling policy based on the principle of geographical proximity results in a huge waste of internal back-to-origin bandwidth resources of the CDN for live streaming. For example, in a live streaming channel of a non-popular streamer, a quantity of viewers is small and the viewers are geographically dispersed. In this case, a large number of edge nodes are occupied and a large number of back-to-origin paths are generated, and a back-to-origin ratio (that is, a back-to-origin bandwidth is divided by an edge bandwidth) is also high, resulting in a low utilization rate of the back-to-origin bandwidth. For example, if only one viewer requests an edge node and requests one portion of back-to-origin, then the back-to-origin ratio is up to 100%. However, if 100 viewers request edge nodes and share one portion of back-to-origin bandwidth, then the back-to-origin ratio is only 1%. Hence, it is helpful to increase the utilization rate of the internal back-to-origin bandwidth resources of the CDN for live streaming, and the technical solutions of the embodiments can effectively increase the utilization rate of the internal back-to-origin bandwidth resources of the CDN for live streaming.

How to perform a data processing operation under the architecture of the network bandwidth aggregation scheduling system in the embodiments is described in detail below.

FIG. 3 is a schematic flowchart of a data processing method according to an embodiment of the present disclosure. This embodiment of the present disclosure is applicable in any scenario in which network bandwidth resources need to be distributed for a multimedia data stream pulling request in a live streaming scenario. This method may be performed by a data processing apparatus. The apparatus may be implemented in a form of software and/or hardware. Optionally, the apparatus is implemented by using an electronic device. The electronic device may be a mobile terminal, a PC terminal, a server, or the like.

As shown in FIG. 3, the method in this embodiment may for example include the following steps.

S110: Acquire, when a target node cluster corresponding to a multimedia data stream acquisition request is found based on a pre-created mapping relationship, target stream pulling information of a current node cluster corresponding to the multimedia data stream acquisition request.

A multimedia data stream refers to live streaming image and audio information that are simultaneously presented in a live streaming page in a live streaming scenario.

The mapping relationship includes stream name information to be selected and a node cluster to be selected. The mapping relationship includes one or more stream names to be selected, and each stream name to be selected corresponds to at least one node cluster to be selected. Stream name information is name information of the multimedia data stream, that is, may be understood as identification information of a live streaming source end. For example, if a name of a specific live streaming channel is “259435”, then stream name information corresponding to the live streaming channel is “259435”. A node cluster is a server cluster that can provide live streaming services to users.

In this embodiment, the mapping relationship is determined based on the following: determining at least one stream name to be filtered; determining a quantity of stream pulling to be used for the at least one stream name to be filtered in at least one regional node cluster; and if there is a node cluster to be selected with the quantity of the stream pulling to be used being greater than a first preset stream pulling quantity threshold, using the stream name to be filtered as the stream name to be selected, and establishing a mapping relationship between the node cluster to be selected and the stream name to be selected.

The stream name to be filtered is the stream name information that is about to undergo filtering processing. For example, a specific implementation of determining the at least one stream name to be filtered may include: counting a quantity of online users based on at least one streaming media server, and feeding back the quantity of online users to a regional scheduler associated with the streaming media server, so that the regional scheduler feeds back the quantity of online users to a scheduling center; and receiving the quantity of online users by the scheduling center, and determining the stream name to be filtered according to a multimedia stream corresponding to the quantity of online users.

In this embodiment, as shown in FIG. 1, one regional scheduler may be associated with one or more stream media servers, and each stream media server may correspond to one particular service region range. For the streaming media servers, a current streaming media server may determine online users within the service region range and a multimedia stream requested by each online user, so that a quantity of online users corresponding to each multimedia stream can be determined. Further, the current streaming media server may feed back each multimedia stream and the quantity of online users corresponding thereto to a regional scheduler associated with the current streaming media server. Then, the regional scheduler may feed back quantities of online users that are reported by the streaming media servers associated therewith to the scheduling center. Hence, the scheduling center may receive the quantities of online users. Because stream name information of a multimedia stream corresponding to each online user is definite, the quantities of online users are counted and summarized based on the stream name information to acquire a total quantity of online users corresponding to each multimedia stream. Still further, total quantities of online users are sorted in descending order. Multimedia streams corresponding to a preset number of top-ranked total quantities of online users are determined as multimedia streams to be processed. Steam name information corresponding to the multimedia streams to be processed is stream names to be filtered. In this embodiment, the stream names to be filtered that correspond to high quantities of online users may be quickly and efficiently determined by reporting the quantities of online users layer by layer and performing summarization and counting.

The regional node cluster is a collection of media stream service nodes within a particular region. In this embodiment, one streaming media server may be considered as one media stream service node. The quantity of the stream pulling to be used is a total quantity of stream pulling requests corresponding to media stream service nodes in one regional node cluster. The first preset stream pulling quantity threshold is a preset threshold. Optionally, the first preset stream pulling quantity threshold may be adjusted according to actual requirements.

In this embodiment, on the basis of determining the at least one stream name to be filtered, a quantity of stream pulling to be used may be determined according to quantities of stream pulling requests correspond to each media stream service node in regional node clusters for stream names to be filtered. Further, whether there is a regional node cluster in which the quantity of the stream pulling to be used is greater than the first preset stream pulling quantity threshold is determined. If there is a regional node cluster in which the quantity of stream pulling to be used is greater than the first preset stream pulling quantity threshold, the regional node cluster is determined as the node cluster to be selected, and the stream name to be filtered is used as the stream name to be selected. Based on the above manner, one or more node clusters to be selected that correspond to each stream name to be selected may be determined. Hence, the mapping relationship between the stream name to be selected and the one or more node clusters to be selected may be established. In this embodiment, the mapping relationship between the stream name to be selected and the one or more node clusters to be selected is predetermined. Because the mapping relationship stores multimedia stream name information with a high user browsing frequency and the node clusters to be selected that correspond to these multimedia stream names, when there is less target stream pulling information of the current node cluster, target node clusters that can be aggregated and scheduled may be quickly and efficiently queried from the mapping relationship.

Optionally, during establishment of the mapping relationship or after establishment of the mapping relationship is completed, the mapping relationship may be updated if any one of the following cases exist, thereby ensuring rationality and availability of the established mapping relationship.

A first case: If an actual load of at least one node cluster element in the node cluster to be selected exceeds a load balancing threshold, the node cluster element is removed from the node cluster to be selected to update the mapping relationship.

The node cluster element in the node cluster to be selected is a media stream service node. The actual load is an actual workload carried by a server of the node cluster element, and the load balancing threshold is a preset workload threshold.

In this embodiment, to ensure service performance of each node element in the node cluster to be selected, and ensure overall service performance of the node cluster to be selected, if an actual load/actual loads of one or more node cluster elements in the node cluster to be selected exceeds/exceed the load balancing threshold, the node cluster elements need to be removed from the node cluster to be selected, and the mapping relationship is updated.

A second case: If a quantity of node cluster elements in at least one node cluster to be selected that is associated with a stream to be selected is less than a preset quantity threshold, the stream to be selected and the at least one associated node cluster to be selected are removed from the mapping relationship, and the mapping relationship is updated.

The stream to be selected is a multimedia data stream corresponding to the stream name to be selected.

In this embodiment, to ensure stability of a system service, if a quantity of node cluster clements in the at least one node cluster to be selected that is associated with the stream to be selected is less than the preset quantity threshold, the stream to be selected and the at least one associated node cluster to be selected are removed from the mapping relationship, and the mapping relationship is updated.

It should be particularly noted that, when the two cases described above exist simultaneously, the mapping relationship is first updated based on a processing manner corresponding to the first case, and then, the mapping relationship is updated based on a processing manner corresponding to the second case, to further ensure rationality and availability of the established mapping relationship.

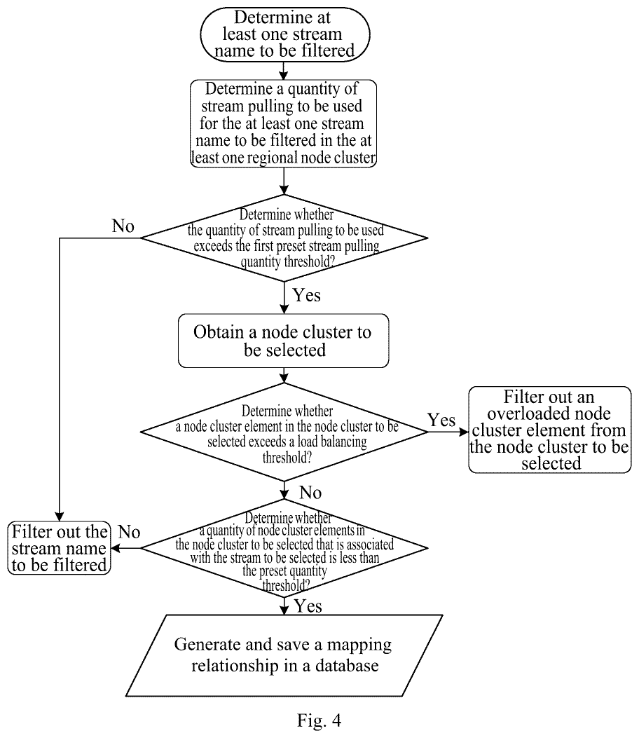

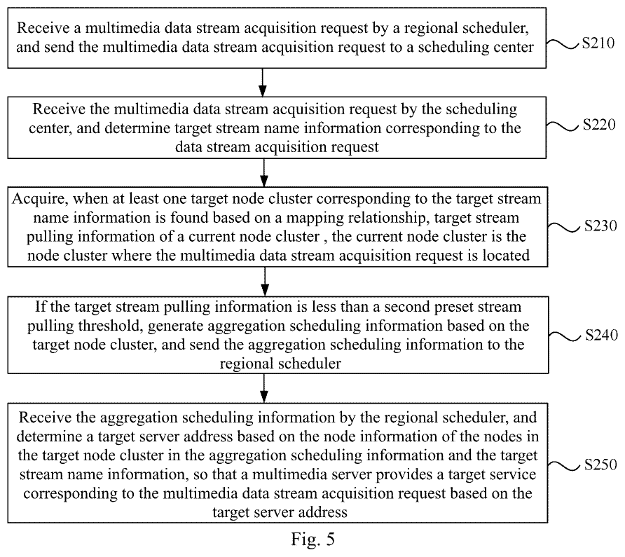

For example, a schematic flowchart of an implementation of determining a mapping relationship is shown in FIG. 4. As shown in FIG. 4, on the basis of determining at least one stream name to be filtered, further, a quantity of stream pulling to be used for the at least one stream name to be filtered in the at least one regional node cluster is determined. Then, whether the quantity of stream pulling to be used exceeds the first preset stream pulling quantity threshold is determined. If the quantity of the stream pulling to be used does not exceed the first preset stream pulling quantity threshold, the stream name to be filtered that corresponds to the quantity of the stream pulling to be used is filtered out. If the quantity of the stream pulling to be used exceeds the first preset stream pulling quantity threshold, the at least one regional node cluster is determined as a node cluster to be selected. Further, whether an actual load of the node cluster element in the node cluster to be selected exceeds the load balancing threshold is determined: if the actual load of the node cluster element in the node cluster to be selected exceeds the load balancing threshold, the overloaded node cluster element is filtered out from the node cluster to be selected; if the actual load of the node cluster element in the node cluster to be selected does not exceed the load balancing threshold, it is further determined that whether a quantity of node cluster elements in the node cluster to be selected that is associated with the stream to be selected is less than the preset quantity threshold: if the quantity of node cluster elements in the node cluster to be selected that is associated with the stream to be selected is less than the preset quantity threshold, the mapping relationship may be generated and saved in a database.

In this embodiment, if one or more node clusters to be selected that correspond to the stream name information can be found from the pre-created mapping relationship according to the stream name information in the multimedia data stream acquisition request, these node clusters to be selected are target node clusters. The current node cluster is a regional node cluster corresponding to the multimedia data stream acquisition request. The target stream pulling information is a total quantity of stream pulling requests corresponding to the current node cluster.

For example, when the user wants to acquire a specific multimedia data stream, a preset media stream acquisition control may be triggered. In this case, a multimedia data stream acquisition request corresponding to the multimedia data stream is generated. The current node cluster where the multimedia data stream acquisition request is located is definite. Because the multimedia data stream acquisition request carries target stream name information of the multimedia data stream, whether the stream name information to be selected in the pre-created mapping relationship is consistent with the target stream name information may be queried. If there is stream name information to be selected that is consistent with the target stream name information, at least one node cluster to be selected that corresponds to the stream name information to be selected is the target node cluster. Quantities of stream pulling requests corresponding to the media stream service nodes in the current node cluster may be counted in real time, and a sum of these quantities of stream pulling requests is the target stream pulling information. When the target node cluster is being searched, the target stream pulling information of the current node cluster is immediately acquired.

For example, the target stream name information carried in the multimedia data stream acquisition request is “259435” and the current node cluster is a node cluster X. If the stream name information to be selected that is queried from the pre-created mapping relationship is “259435”, it may be determined according to the mapping relationship that node clusters to be selected that correspond to the stream name information to be selected “259435” are a node cluster 1, a node cluster 2, and a node cluster 3, that is, the target node clusters include: the node cluster 1, the node cluster 2, and the node cluster 3. In this case, the target stream pulling information of the node cluster X may be acquired, that is, the quantity of the stream pulling is 6842.

S120: determine, when the target stream pulling information meets a preset condition, a target server address corresponding to the multimedia data stream acquisition request based on node information of nodes in the at least one target node cluster and the current node cluster, so that a multimedia server provides a target service corresponding to the multimedia data stream acquisition request based on the target server address.

The preset condition is preset rule information. In this embodiment, the preset condition is that the target stream pulling information is less than a preset stream pulling threshold. The node information is address information, operator information, and the like of the media stream service nodes included in the target node cluster. The target stream name information is a name of a target multimedia stream indicated by the multimedia data stream acquisition request. The target server address is a server address that will eventually provide a multimedia stream service for the multimedia data stream acquisition request. In this embodiment, the multimedia server is the streaming media server in FIG. 1.

For example, when the target stream pulling information of the current node cluster is less than the preset stream pulling threshold, it is possible to attempt to aggregate multimedia stream acquisition requests corresponding to the target stream name information in the current node cluster to any one of target node clusters. In this case, it may be determined, according to the node information of the nodes in the target node clusters, whether there is a target node cluster having an idle load. If there is a target node cluster having an idle load, all the multimedia stream acquisition requests in the current node cluster may be aggregated to the target node cluster. Further, a target node clement is determined from node elements in the target node cluster, according to spatial address information in the multimedia data stream acquisition request and deployment locations of the node elements in the target node cluster; the target node element is the target server address corresponding to the multimedia data stream acquisition request. Hence, the multimedia server may pull the multimedia data stream from the target server address, thereby implementing the target service corresponding to the multimedia data stream acquisition request.

In the technical solutions of the embodiments of the present disclosure, the at least one target node cluster corresponding to the multimedia data stream acquisition request is queried based on the pre-created mapping relationship when the multimedia data stream acquisition request is received. In addition, the target stream pulling information of the current node cluster corresponding to the multimedia data stream acquisition request is acquired. Further, when the target stream pulling information mects the preset condition, the target server address corresponding to the multimedia data stream acquisition request is determined based on the node information of the nodes in the at least one target node cluster and the current node cluster, so that the multimedia server provides the target service corresponding to the multimedia data stream acquisition request based on the target server address. In the technical solutions of the embodiments of the present disclosure, because the mapping relationship stores multimedia stream name information with a high user browsing frequency and a node cluster to be selected that corresponds to these multimedia stream names, a quantity of stream pulling requests corresponding to the node cluster to be selected is relatively large; in a case that a quantity of stream pulling requests of the current node cluster is relatively small, the stream pulling requests having the same as the multimedia stream name information in the current node cluster are aggregated to the target node cluster. Hence, a problem of unbalanced resource allocation during distribution of network bandwidth resources for live stream pulling requests in a live streaming scenario is solved, and a utilization rate of the network bandwidth resources is increased.

FIG. 5 is a schematic flowchart of another data processing method according to an embodiment of the present disclosure. Based on the above embodiment, how to acquire the target stream pulling information of the current node cluster corresponding to the multimedia data stream acquisition request and how to determine the target server address corresponding to the multimedia data stream acquisition request are described in detail in technical solutions of this embodiment. For specific implementations, refer to detailed description of this embodiment of the present disclosure. Details about technical features that are the same as or similar to those in the foregoing embodiment are not repeated herein.

As shown in FIG. 5, the method in this embodiment may for example include the following steps.

S210: Receive a multimedia data stream acquisition request by a regional scheduler, and send the multimedia data stream acquisition request to a scheduling center.

As shown in FIG. 1, when a user triggers a preset media stream acquisition control corresponding to a specific multimedia data stream on a terminal device, a multimedia data stream acquisition request corresponding to the multimedia data stream is generated, and the mobile terminal device may send the multimedia data stream acquisition request to the regional scheduler. The regional scheduler further sends the multimedia data stream acquisition request to the scheduling center after receiving the request.

S220: Receive the multimedia data stream acquisition request by the scheduling center, and determine target stream name information corresponding to the data stream acquisition request.

In this embodiment, after the scheduling center receives the multimedia data stream acquisition request, the scheduling center performs processing such as packet parsing on the multimedia data stream acquisition request, and then reads the target stream name information carried in the multimedia data stream acquisition request.

S230: acquire, when at least one target node cluster corresponding to the target stream name information is found based on a mapping relationship, target stream pulling information of a current node cluster, the current node cluster is the node cluster where the multimedia data stream acquisition request is located.

In a specific implementation process, the mapping relationship is established and updated at the scheduling center. Based on this, the scheduling center acquires the target stream name information through parsing, and performs a query processing on the mapping relationship by using the target stream name information. When stream name information to be selected that is consistent with the target stream name information is queried from the mapping relationship, further, at least one node cluster to be selected that corresponds to the stream name information to be selected may be determined, and the node clusters to be selected are target node clusters. In this case, the target stream pulling information of the current node cluster may be acquired. In this embodiment, through interoperable collaboration of the scheduling center, the regional scheduler, and a stream media server, the mapping relationship may be established in real time, the target stream pulling information of the current node cluster may be accurately determined, and the target node cluster corresponding to the target stream name information may be efficiently and conveniently determined, so that a precise data basis is provided for subsequently determining a target server address corresponding to the multimedia data stream acquisition request.

It should be particularly noted that if the stream name information to be selected that is consistent with the target stream name information is not queried from the mapping relationship, the target stream pulling information of the current node cluster may not be acquired in this case.

Alternatively a live streaming service can be provided for the multimedia data stream acquisition request based on any one streaming media server in the current node cluster.

S240: If the target stream pulling information is less than a second preset stream pulling threshold, generate aggregation scheduling information based on the target node cluster, and send the aggregation scheduling information to the regional scheduler.

The aggregation scheduling information includes aggregation scheduling attribute information and a schedulable target node cluster. The aggregation scheduling attribute information is used to represent whether all multimedia data stream acquisition requests consistent with the target stream name information in the current node cluster can be aggregated.

In this embodiment, if the target stream pulling information is less than the second preset stream pulling threshold, it indicates that the streaming media servers in the current node cluster provide services for only a small number of multimedia data stream requests consistent with the target stream name information. In this case, all the multimedia data stream requests consistent with the target stream name information in the current node cluster may be aggregated. In this case, whether there is a target node cluster having an idle load may be determined according to the node information of the nodes in the at least one target node cluster. If there is a target node cluster having an idle load, the aggregation scheduling information in this case is a scheduling attribute that permits aggregation and identification information corresponding to the target node cluster. If there is no target node cluster having an idle load, the aggregation scheduling information in this case is a scheduling attribute that does not require aggregation. Hence, the scheduling center may send the aggregation scheduling information to the regional scheduler on the basis of determining the aggregation scheduling information.

S250: Receive the aggregation scheduling information by the regional scheduler, and determine a target server address based on the node information of the nodes in the target node cluster in the aggregation scheduling information and the target stream name information, so that a multimedia server provides a target service corresponding to the multimedia data stream acquisition request based on the target server address.

In this embodiment, on the basis of receiving the aggregation scheduling information delivered by the scheduling center, if the aggregation scheduling information is a scheduling attribute that does not require aggregation, the regional scheduler provides a live streaming service for the multimedia data stream acquisition request based on any one streaming media server in the current node cluster. If the aggregation scheduling information is a scheduling attribute that permits aggregation, to further ensure stability of a network bandwidth aggregation scheduling system in an operating process, a loop closure detection may be performed. For example, the loop closure detection is performed on a multimedia stream corresponding to the target stream name information, based on the node information of the nodes in the target node cluster in the aggregation scheduling information and the target stream name information, so as to determine the target server address according to a loop closure detection result.

Optionally, a specific implementation of determining the target server address based on the node information of the nodes in the target node cluster in the aggregation scheduling information and the target stream name information may include: performing a hash check based on the target stream name information and the node information; and if all hash check results meet a verification condition, using a server address in a first node cluster as the target server address. If there is a hash check result that does not meet the verification condition, the target server address is randomly determined from a plurality of server addresses associated with the target node cluster.

The first node cluster is a node cluster in the current node cluster.

In this embodiment, the regional scheduler may perform the hash check by using a consistent hash algorithm based on the target stream name information and the node information, to determine the loop closure detection result. For example, according to a preset verification condition, if all the hash check results meet the verification condition, it represents that the loop closure detection result is that there is a loop closure. In this case, any server address in the current node cluster may be used as the target server address. If there is a hash check result that does not meet the verification condition, it represents that the loop closure detection result is that there is no loop closure. In this case, the target server address may be randomly determined from the plurality of server addresses associated with the target node cluster.

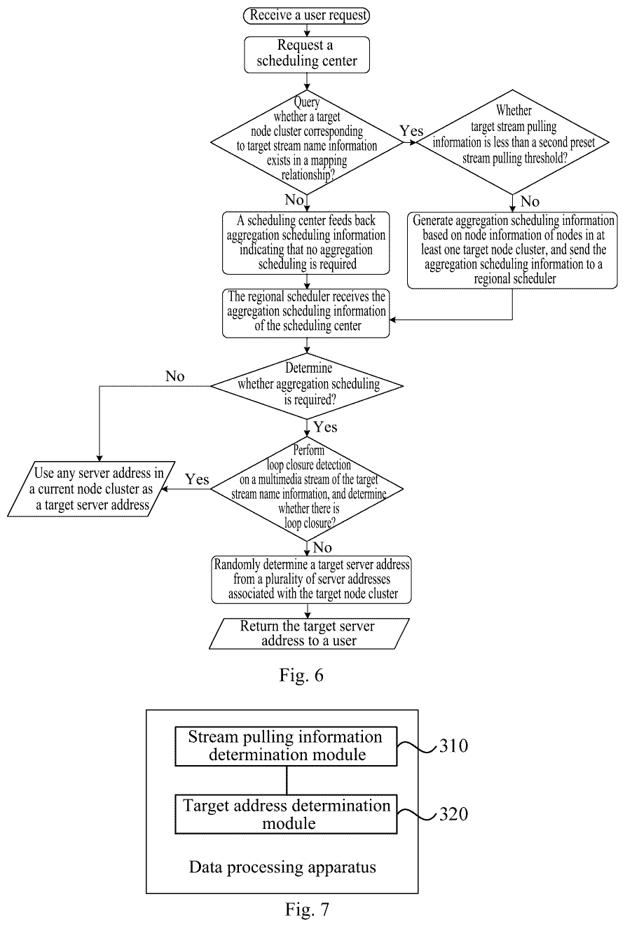

For example, a schematic flowchart of an implementation of determining a target server address is shown in FIG. 6. As shown in FIG. 6, when the regional scheduler receives a multimedia data stream acquisition request of a specific user for a specific live stream, the regional scheduler may send the multimedia data stream acquisition request to the scheduling center. After receiving the multimedia data stream acquisition request, the scheduling center first determines target stream name information corresponding to the multimedia data stream acquisition request, and then find a target node cluster corresponding to the target stream name information based on the mapping relationship. If the target node cluster is found, whether the target stream pulling information of the current node cluster is less than the second preset stream pulling threshold is further determined. If the target stream pulling information of the current node cluster is less than the second preset stream pulling threshold, the aggregation scheduling information is generated based on the node information of the nodes in the at least one target node cluster, and the aggregation scheduling information is sent to the regional scheduler. If the target stream pulling information of the current node cluster is not less than the second preset stream pulling threshold, the aggregation scheduling information indicating the scheduling attribute that does not require aggregation is sent to the regional scheduler. After receiving the aggregation scheduling information, the regional scheduler determines whether an aggregation scheduling needs to be performed on the multimedia data stream acquisition requests corresponding to the target stream name information in the current node cluster. If the aggregation scheduling needs to be performed on the multimedia data stream acquisition requests corresponding to the target stream name information in the current node cluster, a loop closure detection is performed on the multimedia stream corresponding to the target stream name information, and whether there is a loop closure is determined. If loop closure is formed, any server address in the current node cluster is used as the target server address. If no loop closure is formed, the target server address is randomly determined from the plurality of server addresses associated with the target node cluster. Finally, the target server address is fed back to the user.

In the technical solutions of this embodiment of the present disclosure, the multimedia data stream acquisition request is received by the regional scheduler, and the multimedia data stream acquisition request is sent to the scheduling center. Then, the multimedia data stream acquisition request is received by the scheduling center, and the target stream name information corresponding to the data stream acquisition request is determined. Further, when the at least one target node cluster corresponding to the target stream name information is found based on the mapping relationship, the target stream pulling information of the current node cluster corresponding to the multimedia data stream acquisition request is acquired. Through interoperable collaboration of the scheduling center, the regional scheduler, and the stream media servers, the mapping relationship may be established in real time, the target stream pulling information of the current node cluster may be accurately determined, and the target node cluster corresponding to the target stream name information may be efficiently and conveniently determined, so that a precise data basis is provided for subsequently determining the target server address corresponding to the multimedia data stream acquisition request. When the target server address corresponding to the multimedia data stream acquisition request is determined, if the target stream pulling information is less than the second preset stream pulling threshold, the aggregation scheduling information is generated based on the target node cluster, and the aggregation scheduling information is sent to the regional scheduler. The aggregation scheduling information is received by the regional scheduler, and the target server address is determined based on the node information of the nodes in the target node cluster in the aggregation scheduling information and the target stream name information, so that the multimedia server provides the target service corresponding to the multimedia data stream acquisition request based on the target server address. In an implementation process, based on the node information of the nodes in the target node cluster in the aggregation scheduling information and the target stream name information, a loop closure detection is performed on the multimedia stream corresponding to the target stream name information, so as to further ensure stability of the network bandwidth aggregation scheduling system in the operating process.

FIG. 7 is a schematic diagram of a structure of a data processing apparatus according to an embodiment of the present disclosure. As shown in FIG. 7, the apparatus includes: a stream pulling information determination module 310 and a target address determination module 320.

The stream pulling information determination module 310 is configured to acquire, when at least one target node cluster corresponding to a multimedia data stream acquisition request is found based on a pre-created mapping relationship, target stream pulling information of a current node cluster corresponding to the multimedia data stream acquisition request. The mapping relationship includes stream name information to be selected and a node cluster to be selected.

The target address determination module 320 is configured to determine, when the target stream pulling information meets a preset condition, a target server address corresponding to the multimedia data stream acquisition request based on node information of nodes in the at least one target node cluster and the current node cluster, so that a multimedia server provides a target service corresponding to the multimedia data stream acquisition request based on the target server address.

On the basis of the above optional technical solutions, optionally, the data processing apparatus further includes: a mapping relationship determination module. The mapping relationship determination module includes: a stream name-to-be-filtered determination unit, a stream pulling quantity determination unit, and a mapping relationship determination unit.

The stream name-to-be-filtered determination unit is configured to determine at least one stream name to be filtered.

The stream pulling quantity determination unit is configured to determine a quantity of stream pulling to be used for the at least one stream name to be filtered in at least one regional node cluster.

The mapping relationship determination unit is configured to: in response to that there is a node cluster to be selected in which the quantity of the stream pulling to be used is greater than a first preset stream pulling quantity threshold, use the stream name to be filtered as the stream name to be selected, and establish a mapping relationship between the node cluster to be selected and the stream name to be selected.

On the basis of the above optional technical solutions, optionally, the stream name-to-be-filtered determination unit is for example configured to: count a quantity of online users based on at least one streaming media server, and feed back the quantity of online users to a regional scheduler associated with the streaming media server, so that the regional scheduler feeds back the quantity of online users to a scheduling center; and receive the quantity of online users based on the scheduling center, and determine the stream name to be filtered according to a multimedia stream corresponding to the quantity of online users.

On the basis of the above optional technical solutions, optionally, the mapping relationship determination module further includes: a mapping relationship update unit.

The mapping relationship update unit is configured to: in response to that an actual load of at least one node cluster element in the node cluster to be selected exceeds a load balancing threshold, remove the node cluster element from the node cluster to be selected to update the mapping relationship.

The mapping relationship update unit is further configured to: in response to that a quantity of node cluster elements in at least one node cluster to be selected that is associated with the stream to be selected is less than a preset quantity threshold, remove the stream to be selected and the at least one associated node cluster to be selected from the mapping relationship, and update the mapping relationship.

On the basis of the above optional technical solutions, optionally, the stream pulling information determination module 310 includes: a request sending unit, a target stream name determination unit, and a stream pulling information determination unit.

The request sending unit is configured to receive the multimedia data stream acquisition request based on a regional scheduler, and send the multimedia data stream acquisition request to a scheduling center.

The target stream name determination unit is configured to receive the multimedia data stream acquisition request based on the scheduling center, and determine target stream name information corresponding to the data stream acquisition request.

The stream pulling information determination unit is configured to acquire, when the at least one target node cluster corresponding to the target stream name information is found based on the mapping relationship, the target stream pulling information of the current node cluster corresponding to the multimedia data stream acquisition request.

On the basis of the above optional technical solutions, optionally, the target address determination module 320 includes: an aggregation information determination unit and a target address unit.

The aggregation information determination unit is configured to: in response to that the target stream pulling information is less than a second preset stream pulling threshold, generate aggregation scheduling information based on the target node cluster, and send the aggregation scheduling information to a regional scheduler.

The target address unit is configured to receive the aggregation scheduling information based on the regional scheduler, and determine the target server address based on the node information of the nodes in the target node cluster in the aggregation scheduling information and the target stream name information.

On the basis of the above optional technical solutions, optionally, the target address unit is further configured to: perform hash check based on the target stream name information and the node information; and use a server address in a first node cluster as the target server address in response to that all hash check results meet a verification condition, where the first node cluster is a node cluster in the current node cluster.

On the basis of the above optional technical solutions, optionally, the target address unit is further specifically configured to randomly determine the target server address from a plurality of server addresses associated with the target node cluster in response to that there is a hash check result that does not meet the verification condition.

In the technical solutions of this embodiment of the present disclosure, the target stream pulling information of the target node cluster is acquired when the target node cluster corresponding to the multimedia data stream acquisition request is found based on the pre-created mapping relationship. The mapping relationship includes stream name information to be selected and a node cluster to be selected. When the target stream pulling information meets the preset condition, the target server address corresponding to the multimedia data stream acquisition request is determined based on the node information of the nodes in the target node cluster and the target stream name information corresponding to the multimedia data stream acquisition request, so that the multimedia server provides the target service corresponding to the multimedia data stream acquisition request based on the target server address. In the technical solutions of this embodiment of the present disclosure, when a special effect prop is created or a special effect is displayed, a special effect corresponding to a multimedia data stream may be displayed, thereby improving universality of special effect creation or usage.

The data processing apparatus provided in this embodiment of the present disclosure may perform the data processing method provided in any one of the embodiments of the present disclosure, and has corresponding functional modules for performing the method and corresponding beneficial effects.

It is worth noting that the units and modules included in the above apparatus are acquired through division merely according to functional logic, but are not limited to the above division, as long as corresponding functions can be implemented. In addition, specific names of the functional units are merely used for mutual distinguishing, and are not used to limit the scope of protection of the embodiments of the present disclosure.

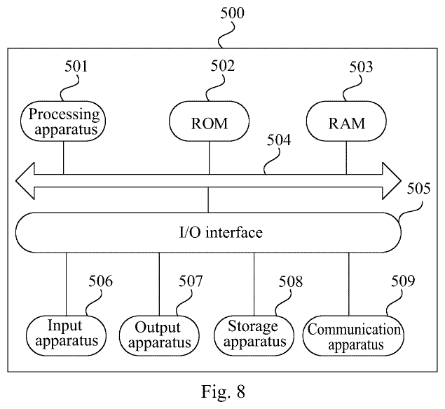

FIG. 8 is a schematic diagram of a structure of an electronic device according to an embodiment of the present disclosure. Referring to FIG. 8, FIG. 8 is a schematic diagram of a structure of an electronic device (for example, a terminal device or a server in FIG. 8) 500 suitable for implementing the embodiments of the present disclosure. A terminal device in this embodiment of the present disclosure may include, but is not limited to, mobile terminals such as a mobile phone, a notebook computer, a digital broadcast receiver, a personal digital assistant (PDA), a tablet computer (PAD), a portable media player (PMP), and a vehicle-mounted terminal (c.g., a vehicle navigation terminal), and fixed terminals such as a digital TV and a desktop computer. The electronic device shown in FIG. 8 is merely an example, and shall not impose any limitation on the function and scope of use of the embodiments of the present disclosure.

As shown in FIG. 8, the electronic device 500 may include a processing apparatus (c.g., a central processing unit or a graphics processing unit) 501 that may perform a variety of appropriate actions and processing in accordance with a program stored in a read-only memory (ROM) 502 or a program loaded from a storage apparatus 508 into a random access memory (RAM) 503. The RAM 503 further stores various programs and data required for the operation of the electronic device 500. The processing apparatus 501, the ROM 502, and the RAM 503 are connected to one another through a bus 504. An input/output (I/O) interface 505 is also connected to the bus 504.

Generally, the following apparatuses may be connected to the I/O interface 505: an input apparatus 506 including, for example, a touchscreen, a touchpad, a keyboard, a mouse, a camera, a microphone, an accelerometer, and a gyroscope; an output apparatus 507 including, for example, a liquid crystal display (LCD), a speaker, and a vibrator; the storage apparatus 508 including, for example, a tape and a hard disk; and a communication apparatus 509. The communication apparatus 509 may allow the electronic device 500 to perform wireless or wired communication with other devices to exchange data. Although FIG. 8 shows the electronic device 500 having various apparatuses, it should be understood that it is not required to implement or have all of the shown apparatuses. It may be an alternative to implement or have more or fewer apparatuses.

In particular, according to an embodiment of the present disclosure, the process described above with reference to the flowchart may be implemented as a computer software program. For example, this embodiment of the present disclosure includes a computer program product, which includes a computer program carried on a non-transitory computer-readable medium, where the computer program includes program code for performing the method shown in the flowchart. In such an embodiment, the computer program may be downloaded and installed from a network through the communication apparatus 509, installed from the storage apparatus 508, or installed from the ROM 502. When the computer program is executed by the processing apparatus 501, the above-mentioned functions defined in the method of the embodiment of the present disclosure are performed.

The names of messages or information exchanged between a plurality of apparatuses in the implementations of the present disclosure are used for illustrative purposes only, and are not used to limit the scope of these messages or information.

The electronic device according to this embodiment of the present disclosure and the data processing method according to the above embodiment belong to the same inventive concept. For the technical details not exhaustively described in this embodiment of the present disclosure, reference may be made to the above embodiment, and this embodiment and the above embodiment have the same beneficial effects.

An embodiment of the present disclosure provides a computer storage medium storing a computer program thereon, where the program, when executed by a processor, causes the data processing method according to the above embodiment to be implemented.

It should be noted that the above computer-readable medium described in the present disclosure may be a computer-readable signal medium, a computer-readable storage medium, or any combination thereof. The computer-readable storage medium may be, for example but not limited to, electric, magnetic, optical, electromagnetic, infrared, or semiconductor systems, apparatuses, or devices, or any combination thereof. More specific examples of the computer-readable storage medium may include, but are not limited to: an electrical connection having one or more wires, a portable computer magnetic disk, a hard disk, a random access memory (RAM), a read-only memory (ROM), an erasable programmable read-only memory (EPROM) (or a flash memory), an optical fiber, a portable compact disc read-only memory (CD-ROM), an optical storage device, a magnetic storage device, or any suitable combination thereof. In the present disclosure, the computer-readable storage medium may be any tangible medium containing or storing a program which may be used by or in combination with an instruction execution system, apparatus, or device. In the present disclosure, the computer-readable signal medium may include a data signal propagated in a baseband or as a part of a carrier, the data signal carrying computer-readable program code. The propagated data signal may be in various forms, including but not limited to an electromagnetic signal, an optical signal, or any suitable combination thereof. The computer-readable signal medium may further be any computer-readable medium other than the computer-readable storage medium. The computer-readable signal medium can send, propagate, or transmit a program used by or in combination with an instruction execution system, apparatus, or device. The program code contained in the computer-readable medium may be transmitted by any suitable medium, including but not limited to: electric wires, optical cables, radio frequency (RF), etc., or any suitable combination thereof.

In some implementations, a client and a server may communicate using any currently known or future-developed network protocol such as the Hypertext Transfer Protocol (HTTP), and may be connected to digital data communication (for example, a communication network) in any form or medium. Examples of the communication network include a local area network (“LAN”), a wide area network (“WAN”), an internetwork (for example, the internet), a peer-to-peer network (for example, an ad hoc peer-to-peer network), and any currently known or future-developed network.

The above computer-readable medium may be contained in the above electronic device. Alternatively, the computer-readable medium may exist independently, without being assembled into the electronic device.

The above computer-readable medium carries one or more programs that, when executed by the electronic device, cause the electronic device to: acquire, when at least one target node cluster corresponding to a multimedia data stream acquisition request is found based on a pre-created mapping relationship, target stream pulling information of a current node cluster corresponding to the multimedia data stream acquisition request, where the mapping relationship includes stream name information to be selected and a node cluster to be selected; and determine a target server address corresponding to the multimedia data stream acquisition request based on node information of nodes in the at least one target node cluster and the current node cluster when the target stream pulling information meets a preset condition, so that a multimedia server provides a target service corresponding to the multimedia data stream acquisition request based on the target server address.

Computer program code for performing operations of the present disclosure can be written in one or more programming languages or a combination thereof, where the programming languages include but are not limited to object-oriented programming languages, such as Java, Smalltalk, and C++, and further include conventional procedural programming languages, such as “C” language or similar programming languages. The program code may be completely executed on a computer of a user, partially executed on a computer of a user, executed as an independent software package, partially executed on a computer of a user and partially executed on a remote computer, or completely executed on a remote computer or server. In the case of the remote computer, the remote computer may be connected to the computer of the user through any kind of network, including a local area network (LAN) or a wide area network (WAN), or may be connected to an external computer (for example, connected through the internet with the aid of an internet service provider).

The flowchart and block diagram in the accompanying drawings illustrate the possibly implemented architecture, functions, and operations of the system, method, and computer program product according to various embodiments of the present disclosure. In this regard, each block in the flowchart or block diagram may represent a module, program segment, or part of code, and the module, program segment, or part of code contains one or more executable instructions for implementing the specified logical functions. It should also be noted that, in some alternative implementations, the functions marked in the blocks may also occur in an order different from that marked in the accompanying drawings. For example, two blocks shown in succession can actually be performed substantially in parallel, or they can sometimes be performed in the reverse order, depending on the functions involved. It should also be noted that each block in the block diagram and/or the flowchart, and a combination of the blocks in the block diagram and/or the flowchart may be implemented by a dedicated hardware-based system that executes specified functions or operations, or may be implemented by a combination of dedicated hardware and computer instructions.

The related units described in the embodiments of the present disclosure may be implemented by software, or may be implemented by hardware. Names of the units do not constitute a limitation on the units themselves in some cases, for example, a first acquisition unit may alternatively be described as “a unit for acquiring at least two internet protocol addresses”.

The functions described herein above may be performed at least partially by one or more hardware logic components. For example, without limitation, exemplary types of hardware logic components that may be used include: a field programmable gate array (FPGA), an application-specific integrated circuit (ASIC), an application-specific standard product (ASSP), a system-on-chip (SOC), a complex programmable logic device (CPLD), and the like.

In the context of the present disclosure, a machine-readable medium may be a tangible medium that may contain or store a program used by or in combination with an instruction execution system, apparatus, or device. The machine-readable medium may be a machine-readable signal medium or a machine-readable storage medium. The machine-readable medium may include, but is not limited to, an electronic, magnetic, optical, electromagnetic, infrared, or semiconductor system, apparatus, or device, or any suitable combination thereof. More specific examples of the machine-readable storage medium may include an electrical connection based on one or more wires, a portable computer disk, a hard disk, a random access memory (RAM), a read-only memory (ROM), an crasable programmable read-only memory (EPROM) (or a flash memory), an optic fiber, a portable compact disc read-only memory (CD-ROM), an optical storage device, a magnetic storage device, or any suitable combination thereof.

The foregoing descriptions are merely preferred embodiments of the present disclosure and explanations of the applied technical principles. Those skilled in the art should understand that the scope of disclosure involved in the present disclosure is not limited to the technical solutions formed by specific combinations of the foregoing technical features, and shall also cover other technical solutions formed by any combination of the foregoing technical features or equivalent features thereof without departing from the foregoing concept of disclosure. For example, a technical solution formed by a replacement of the foregoing features with technical features with similar functions disclosed in the present disclosure (but not limited thereto) also falls within the scope of the present disclosure.

In addition, although the various operations are depicted in a specific order, it should not be construed as requiring these operations to be performed in the specific order shown or in a sequential order. Under certain circumstances, multitasking and parallel processing may be advantageous. Similarly, although several specific implementation details are included in the foregoing discussions, these details should not be construed as limiting the scope of the present disclosure. Some features that are described in the context of separate embodiments can also be implemented in combination in a single embodiment. In contrast, various features described in the context of a single embodiment may alternatively be implemented in a plurality of embodiments individually or in any suitable subcombination.

Although the subject matter has been described in a language specific to structural features and/or logical actions of the method, it should be understood that the subject matter defined in the appended claims is not necessarily limited to the specific features or actions described above. In contrast, the specific features and actions described above are merely exemplary forms of implementing the claims.

1. A data processing method, comprising:
acquiring, when at least one target node cluster corresponding to a multimedia data stream acquisition request is found based on a pre-created mapping relationship, target stream pulling information of a current node cluster corresponding to the multimedia data stream acquisition request, wherein the mapping relationship comprises stream name information to be selected and a node cluster to be selected; and
determining, when the target stream pulling information meets a preset condition, a target server address corresponding to the multimedia data stream acquisition request based on node information of nodes in the at least one target node cluster and the current node cluster, so that a multimedia server provides a target service corresponding to the multimedia data stream acquisition request based on the target server address.

2. The method according to claim 1, wherein the mapping relationship is determined based on the following:
determining at least one stream name to be filtered;
determining a quantity of a stream pulling to be used for the at least one stream name to be filtered in at least one regional node cluster; and
in response to that there is a node cluster to be selected in which the quantity of the stream pulling to be used is greater than a first preset stream pulling quantity threshold, using the at least one stream name to be filtered as a stream name to be selected, and establishing the mapping relationship between the node cluster to be selected and the stream name to be selected.

3. The method according to claim 2, wherein the determining at least one stream name to be filtered comprises:
counting a quantity of online users by at least one streaming media server, and feeding back the quantity of online users to a regional scheduler associated with at least one the streaming media server, so that the regional scheduler feeds back the quantity of online users to a scheduling center; and
receiving the quantity of online users by the scheduling center, and determining the stream name to be filtered according to a multimedia stream corresponding to the quantity of online users.

4. The method according to claim 2, wherein the method further comprises:
in response to that an actual load of at least one node cluster element in the node cluster to be selected exceeds a load balancing threshold, removing the node cluster element from the node cluster to be selected to update the mapping relationship.

5. The method according to claim 4, wherein the method further comprises:
in response to that a quantity of node cluster elements in at least one node cluster to be selected that is associated with the stream to be selected is less than a preset quantity threshold, removing the stream to be selected and the at least one associated node cluster to be selected from the mapping relationship, and updating the mapping relationship.

6. The method according to claim 2, wherein the method further comprises:
in response to that a quantity of node cluster elements in at least one node cluster to be selected that is associated with the stream to be selected is less than a preset quantity threshold, removing the stream to be selected and the at least one associated node cluster to be selected from the mapping relationship, and updating the mapping relationship.

7. The method according to claim 1, wherein the acquiring, when at least one target node cluster corresponding to a multimedia data stream acquisition request is found based on a pre-created mapping relationship, target stream pulling information of a current node cluster corresponding to the multimedia data stream acquisition request comprises:
receiving the multimedia data stream acquisition request by a regional scheduler, and sending the multimedia data stream acquisition request to a scheduling center;
receiving the multimedia data stream acquisition request by the scheduling center, and determining target stream name information corresponding to the multimedia data stream acquisition request; and
acquiring, when the at least one target node cluster corresponding to the target stream name information is found based on the mapping relationship, the target stream pulling information of the current node cluster corresponding to the multimedia data stream acquisition request.

8. The method according to claim 1, wherein the determining, when the target stream pulling information meets a preset condition, a target server address corresponding to the multimedia data stream acquisition request based on node information of nodes in the at least one target node cluster and the current node cluster comprises:
in response to that the target stream pulling information is less than a second preset stream pulling threshold, generating aggregation scheduling information based on the target node cluster, and sending the aggregation scheduling information to a regional scheduler; and
receiving the aggregation scheduling information by the regional scheduler, and determining the target server address based on the node information of the nodes in the target node cluster in the aggregation scheduling information and a target stream name information.

9. The method according to claim 8, wherein the determining the target server address based on the node information of the nodes in the target node cluster in the aggregation scheduling information and the target stream name information comprises:
performing a hash check based on the target stream name information and the node information; and
using a server address in a first node cluster as the target server address in response to that all hash check results meet a verification condition, wherein the first node cluster is a node cluster in the current node cluster.

10. The method according to claim 9, wherein the method further comprises:
randomly determining the target server address from a plurality of server addresses associated with the target node cluster in response to that there is a hash check result that does not meet the verification condition.

11. An electronic device, comprising:
one or more processors; and
a storage apparatus, configured to store one or more programs, wherein
the one or more programs, when executed by the one or more processors, cause the one or more processors to implement a data processing method, wherein the data processing method comprises:
acquiring, when at least one target node cluster corresponding to a multimedia data stream acquisition request is found based on a pre-created mapping relationship, target stream pulling information of a current node cluster corresponding to the multimedia data stream acquisition request, wherein the mapping relationship comprises stream name information to be selected and a node cluster to be selected; and
determining, when the target stream pulling information meets a preset condition, a target server address corresponding to the multimedia data stream acquisition request based on node information of nodes in the at least one target node cluster and the current node cluster, so that a multimedia server provides a target service corresponding to the multimedia data stream acquisition request based on the target server address.

12. The electronic device according to claim 11, wherein the mapping relationship is determined based on the following:
determining at least one stream name to be filtered;
determining a quantity of a stream pulling to be used for the at least one stream name to be filtered in at least one regional node cluster; and
in response to that there is a node cluster to be selected in which the quantity of the stream pulling to be used is greater than a first preset stream pulling quantity threshold, using the at least one stream name to be filtered as a stream name to be selected, and establishing the mapping relationship between the node cluster to be selected and the stream name to be selected.

13. The electronic device according to claim 12, wherein the determining at least one stream name to be filtered comprises:
counting a quantity of online users by at least one streaming media server, and feeding back the quantity of online users to a regional scheduler associated with at least one the streaming media server, so that the regional scheduler feeds back the quantity of online users to a scheduling center; and
receiving the quantity of online users by the scheduling center, and determining the stream name to be filtered according to a multimedia stream corresponding to the quantity of online users.

14. The electronic device according to claim 12, wherein the method further comprises:
in response to that an actual load of at least one node cluster element in the node cluster to be selected exceeds a load balancing threshold, removing the node cluster element from the node cluster to be selected to update the mapping relationship.

15. The electronic device according to claim 14, wherein the method further comprises:
in response to that a quantity of node cluster elements in at least one node cluster to be selected that is associated with the stream to be selected is less than a preset quantity threshold, removing the stream to be selected and the at least one associated node cluster to be selected from the mapping relationship, and updating the mapping relationship.

16. The electronic device according to claim 12, wherein the method further comprises:
in response to that a quantity of node cluster elements in at least one node cluster to be selected that is associated with the stream to be selected is less than a preset quantity threshold, removing the stream to be selected and the at least one associated node cluster to be selected from the mapping relationship, and updating the mapping relationship.

17. The electronic device according to claim 11, wherein the acquiring, when at least one target node cluster corresponding to a multimedia data stream acquisition request is found based on a pre-created mapping relationship, target stream pulling information of a current node cluster corresponding to the multimedia data stream acquisition request comprises:
receiving the multimedia data stream acquisition request by a regional scheduler, and sending the multimedia data stream acquisition request to a scheduling center;
receiving the multimedia data stream acquisition request by the scheduling center, and determining target stream name information corresponding to the multimedia data stream acquisition request; and
acquiring, when the at least one target node cluster corresponding to the target stream name information is found based on the mapping relationship, the target stream pulling information of the current node cluster corresponding to the multimedia data stream acquisition request.

18. The electronic device according to claim 11, wherein the determining, when the target stream pulling information meets a preset condition, a target server address corresponding to the multimedia data stream acquisition request based on node information of nodes in the at least one target node cluster and the current node cluster comprises:
in response to that the target stream pulling information is less than a second preset stream pulling threshold, generating aggregation scheduling information based on the target node cluster, and sending the aggregation scheduling information to a regional scheduler; and
receiving the aggregation scheduling information by the regional scheduler, and determining the target server address based on the node information of the nodes in the target node cluster in the aggregation scheduling information and a target stream name information.

19. The electronic device according to claim 18, wherein the determining the target server address based on the node information of the nodes in the target node cluster in the aggregation scheduling information and the target stream name information comprises:
performing a hash check based on the target stream name information and the node information; and
using a server address in a first node cluster as the target server address in response to that all hash check results meet a verification condition, wherein the first node cluster is a node cluster in the current node cluster.

20. A non-transitory storage medium having computer-executable instructions, wherein the computer-executable instructions, when executed by a computer processor, are used to perform a data processing method, wherein the data processing method comprises:
acquiring, when at least one target node cluster corresponding to a multimedia data stream acquisition request is found based on a pre-created mapping relationship, target stream pulling information of a current node cluster corresponding to the multimedia data stream acquisition request, wherein the mapping relationship comprises stream name information to be selected and a node cluster to be selected; and
determining, when the target stream pulling information meets a preset condition, a target server address corresponding to the multimedia data stream acquisition request based on node information of nodes in the at least one target node cluster and the current node cluster, so that a multimedia server provides a target service corresponding to the multimedia data stream acquisition request based on the target server address.
